(19) United States
(12) Patent Application Publication
(10) Pub. No.: US 2025/0062549 A1
(43) Pub. Date: Feb. 20, 2025

(54) CONNECTOR AND CONNECTOR ASSEMBLY

(71) Applicants: Tyco Electronics (Shanghai) Co., Ltd., Shanghai (CN); TE Connectivity Svenska AB, Upplands Vasby (SE)

(72) Inventors: Jiaoyong (Mac) Liu, Shanghai (CN); Jie (Roger) Luo, Foshan (CN); Hans Magnus Emil Andersson, Kista (SE); Wei Yao, Kunshan (CN)

(73) Assignees: Tyco Electronics (Shanghai) Co., Ltd., Shanghai (CN); TE Connectivity Svenksa AB, Upplands Vasby (SE)

(21) Appl. No.: 18/804,537

(22) Filed: Aug. 14, 2024

(30) Foreign Application Priority Data
Aug. 14, 2023 (CN) 202311021875.5

(51) Int. Cl. H01R 4/2475; H01R 4/18; H01R 12/71; H01R 13/502; H01R 13/52; H01R 13/6582; H01R 13/6594; H01R 25/16

(52) U.S. Cl. CPC H01R 4/2475; H01R 4/18; H01R 12/712; H01R 13/502; H01R 13/5202; H01R 13/6582; H01R 13/6594; H01R 25/161

(57) ABSTRACT

A connector comprises a first fastener and a housing. The first fastener is arranged on the housing and is adapted to secure a wire between the housing and the first fastener. The housing includes at least one side wall, and a finger extending from one end of the at least one side wall. The at least one side wall includes a shoulder adapted to withstand external force applied to crimp the finger into a circuit board. A height from the shoulder to the one end of the at least one side wall is sufficient to prevent deformation of the housing during crimping of the finger to the circuit board.

### CROSS-REFERENCE TO RELATED APPLICATION

This application claims the priority of Chinese Patent Application No. CN 202311021875.5 filed on Aug. 14, 2023, the whole disclosure of which is incorporated herein by reference.

### FIELD OF THE DISCLOSURE

The present disclosure relates to a connector and a connector assembly, in particular to a connector and a connector assembly with high signal integrity and reliability.

### BACKGROUND

A connector is a component used to connect two active devices to transmit current or signals. A connector may simplify an assembly process of electronic product and also simplify a mass production process of the electronic products. Generally, a connector is easy to repair, and if an electronic component fails, the failed component may be quickly replaced with a connector installed. With an advancement of technology, the electronic product or device provided with a connector may use updated electronic components, replacing old electronic components with new and better performing ones for easy upgrading. A connector may enhance a flexibility of product design when designing and integrating a new product, as well as when composing a system with electronic components. Therefore, connectors are widely used in fields such as transportation, healthcare, aerospace, military, and home appliances.

The basic performances of a connector may be divided into three categories: mechanical performance, electrical performance, and environmental performance. Insertion and extraction force and mechanical life are important mechanical performances. The insertion and extraction force and mechanical life of a connector are related to a structure of a contact (a magnitude of a positive pressure), a quality of a coating on a contact area (sliding friction coefficient), and an accuracy of a size of an arrangement of the contacts (alignment precision).

Main electrical performances of a connector comprise a contact resistance, an insulation resistance, and a dielectric strength. Among them, a high-quality electrical connector should have a low and stable contact resistance, which ranges from a few milliohms to tens of milliohms. An insulation resistance is an index that measures the insulation performance between the contacts of an electrical connector and between the contacts and a housing of the connector. An order of magnitude of the insulation resistance ranges from hundreds of megaohms to thousands of megaohms. Dielectric strength is an ability of a connector to withstand a rated test voltage between the contacts of the connector or between the contacts and the housing. Environmental performance comprises a temperature resistance, a humidity resistance, a salt spray resistance, a vibration and an impact resistance, etc.

Development of connector technology is aimed at the following characteristics, by way of example: high-speed and digitalization of signal transmission; integration of various signal transmissions, miniaturization of product volume; low cost of products; modular combination; convenience of insertion and extraction.

A connector of the prior art must be crimped into a circuit board under an external force. However, they are prone to deform under the external force, resulting in a damage to the connector. In order to secure a wire to the connector with a high torque, a nut needs to be installed inside the connector. However, due to a gap between the nut and the connector, a signal distortion, such as a passive intermodulation, occurs. This results in a poor signal integrity. Additionally, due to a small size of the nut, it is easy to fall off and difficult to install, resulting in a low reliability of the prior art connector.

### SUMMARY

According to an embodiment of the present disclosure, a connector comprises a first fastener and a housing. The first fastener is arranged on the housing and is adapted to secure a wire between the housing and the first fastener. The housing includes at least one side wall, and a finger extending from one end of the at least one side wall. The at least one side wall includes a shoulder adapted to withstand external force applied to crimp the finger into a circuit board. A height from the shoulder to the one end of the at least one side wall is sufficient to prevent deformation of the housing during crimping of the finger to the circuit board.

### BRIEF DESCRIPTION OF THE DRAWINGS

The accompanying drawings incorporated therein and forming a part of the specification illustrate the present disclosure and, and together with the description, further serve to explain the principles of the disclosure and to enable those skilled in the relevant art to manufacture and use the embodiments described herein.

FIG. 1 is a perspective view of a connector crimped onto a circuit board according to an embodiment of the present disclosure;

FIG. 2 is an exploded view of the connector shown in FIG. 1;

FIG. 3 is a front view of the connector shown in FIG. 1;

FIG. 4 is a side view of the connector shown in FIG. 1;

FIG. 5 is a cross-sectional view of the connector taken along a line V-V shown in FIG. 1, showing a first fastener, a second fastener, and a shielding member assembled together;

FIG. 6 is a perspective view of the second fastener and the shielding member assembled together in FIG. 2;

FIG. 7 is a perspective view of the second fastener in FIG. 2 and the shielding member according to another embodiment of the present disclosure assembled together;

FIG. 8 is a perspective view of the individual shielding member in FIG. 7; and

FIG. 9 is a perspective view of a connector assembly according to an embodiment of the present disclosure.

The features disclosed in this disclosure will become more apparent in the following detailed description in conjunction with the accompanying drawings, where similar reference numerals always identify the corresponding components. In the accompanying drawings, similar reference numerals typically represent identical, functionally similar, and/or structurally similar components. Unless otherwise stated, the drawings provided throughout the entire disclosure should not be construed as drawings drawn to scale.

### DETAILED DESCRIPTION OF THE EMBODIMENTS

In order to make the purpose, technical scheme and advantages of the present disclosure more clear, the following is a detailed explanation of the present disclosure, combined with specific embodiments and referring to the attached drawings.

However, it should be understood that these descriptions are only illustrative and not intended to limit the scope of the present disclosure. In the following detailed description, for ease of interpretation, many specific details are elaborated to provide a comprehensive understanding of the embodiments of the present disclosure. However, it is evident that one or more embodiments may also be implemented without these specific details. In addition, in the following explanation, the description of the well-known technology is omitted to avoid unnecessary confusion with the concept of the present disclosure.

The terms used here are only for describing specific embodiments and are not intended to limit the present disclosure. The term “comprising” used here indicates the existence of features, steps and operations, but does not exclude the existence or addition of one or more other features.

In the case of using expressions such as “at least one of A, B, and C, etc.” or the like, it should generally be interpreted in accordance with the meaning of the expressions that those skilled in the art usually understand (for example, “a system with at least one of A, B, and C” should comprise but not be limited to a system with only A, a system with only B, a system with only C, a system with A and B, a system with A and C, a system with B and C, and/or a system with A, B, C, etc.).

All terms used here (comprising technical and scientific terms) have the meanings commonly understood by those skilled in the art, unless otherwise defined. It should be noted that the terms used here should be interpreted as having a meaning consistent with the context of this specification, and should not be interpreted in an idealized or overly rigid manner.

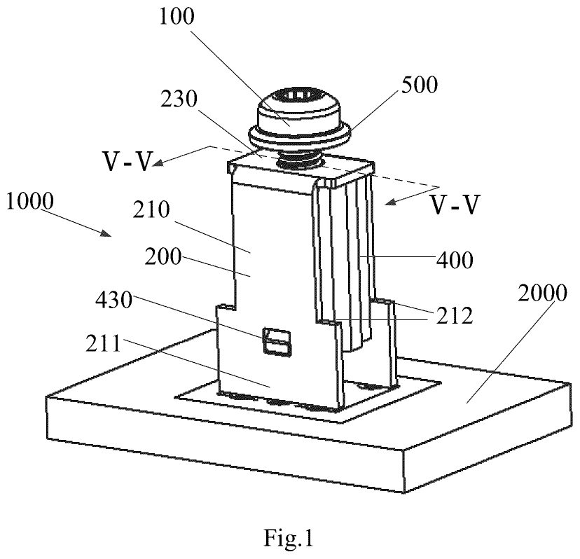

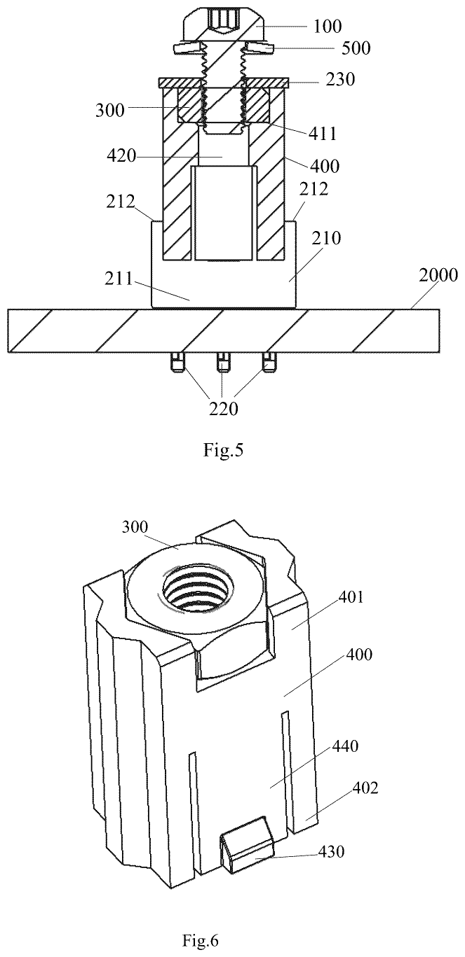

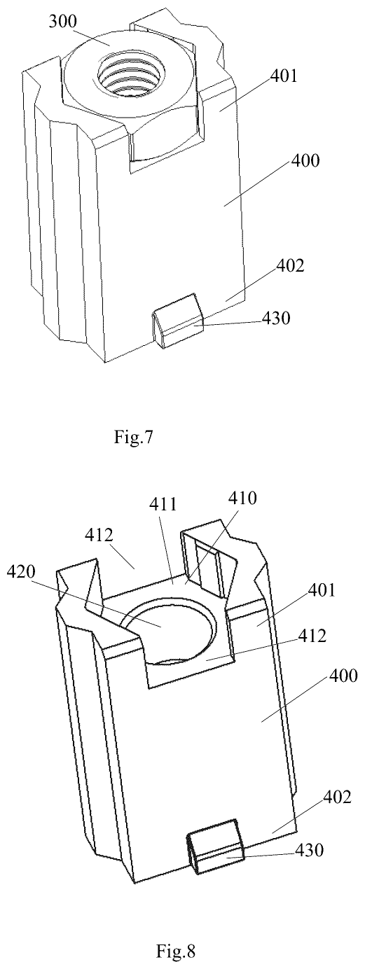

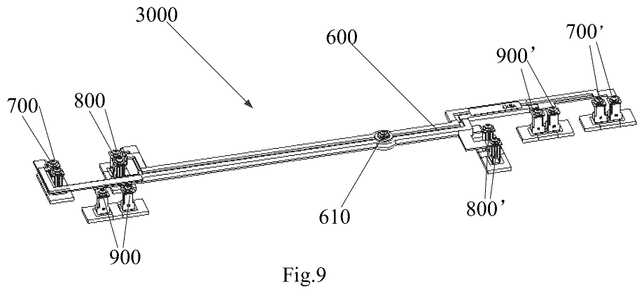

Referring to FIGS. 1-8, a connector 1000 according to an embodiment of the present disclosure is shown. The connector 1000 comprises: a first fastener 100 and a housing 200 made of metal. The first fastener 100 is provided on the housing 200 to secure the wire (see FIG. 9, i.e. the wire connected to a bus 600) between the housing 200 and the first fastener 100.

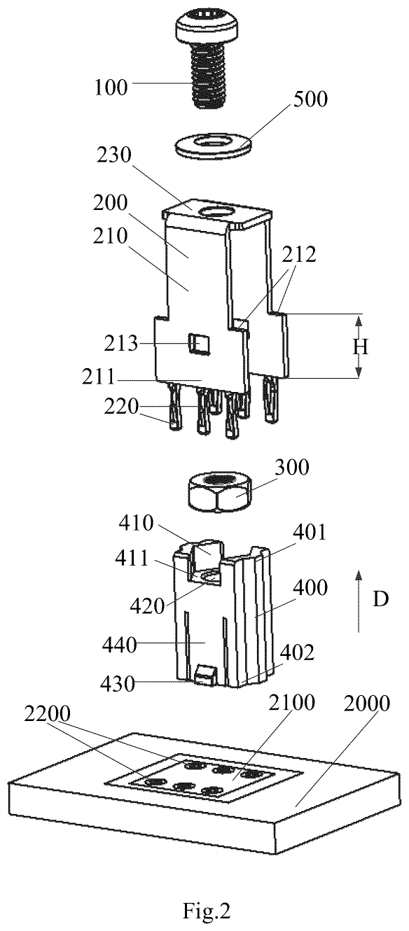

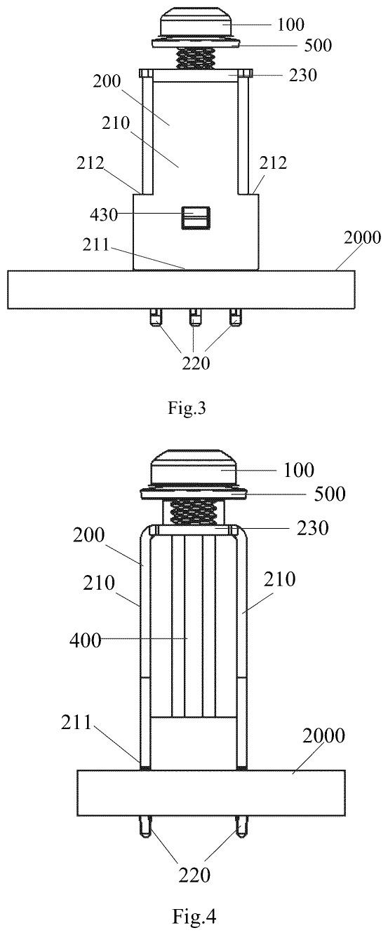

The housing 200 comprises two opposite side walls 210 and six fingers 220 extending from ends 211 of the side walls 210 towards a circuit board 2000, wherein, each of the side walls 210 is provided with three fingers 220 extending from its end 211. The circuit board 2000 is provided with a connecting area 2100 and six through holes 2200 provided in the connecting area (see FIG. 2). Each of the side walls 210 is provided with at least one shoulder 212, which is configured for withstanding an external force applied so as to crimp the six fingers 220 to the corresponding through holes 2200 of the circuit board 2000 respectively, so that each of the fingers 220 passes through the corresponding one of the through holes 2200 and is exposed from the through hole 2200 (see FIGS. 3-5). Therefore, the wire is electrically connected to a circuit on the circuit board 2000 through the fingers 220 of the housing 200 and the through holes 2200 where are inserted by the fingers 220.

A height H (see FIG. 2) from the shoulder 212 to the end 211 (more specifically, where the three fingers 220 and the side wall 210 are connected to each other) of the side wall 210 is selected so as to ensure that the housing 200 does not deform during the crimping process, greatly improving a reliability of the connector 1000.

More specifically, the housing 200 further comprises a top wall 230 connected between the two opposite side walls 210. The arrangement of shoulder 212 avoids the external force being applied to the top wall 230 of the housing 200, greatly reducing a height from a part of the housing 200 which is subject to the external force to the circuit board 2000, effectively reducing or even eliminating a risk of deformation of the housing 200 and damage to the connector 1000 due to the external force applied to the housing 200 being excessive during the process of crimping the fingers 220 into the through holes 2200 of the circuit board 2000. According to an expected magnitude of the external force, the height H from the shoulder 212 to the end 211 of the side wall 210 may be adjusted. For example, when the applied external force is larger, a magnitude of the height H may be set to be smaller, and when the applied external force is smaller, the magnitude of the height H may be set to be larger, greatly expanding an applicability of the connector 1000.

The first fastener 100 is provided on the top wall 230 and configured to extend through the top wall 230.

Referring to FIGS. 2 and 5-8, the connector 1000 further comprises a second fastener 300, a shielding member 400, and a gasket 500. The second fastener 300 is provided below the top wall 230 between the two side walls 210 and is matched with the first fastener 100 so as to secure the wire. The first fastener 100 is configured as a bolt, the second fastener 300 is configured as a nut, and the gasket 500 is abutted against below a head of the bolt so as to secure the wire between the top wall 230 of the housing 200 and the gasket 500.

The shielding member 400 is provided between the two side walls 210 so as to at least partially wrap or completely wrap the second fastener 300 and a portion of the first fastener 100 passing through the top wall 230 together with the housing 200, so that there is no gap between the second fastener 300 and the housing 200. An absence of the gap between the second fastener 300 and the housing 200 not only greatly eliminates a signal distortion, such as passive intermodulation, caused by this gap, improves a signal integrity of the connector 1000, but also makes the second fastener 300 more firmly installed in the housing 200 and less prone to falling, further improving the reliability of the connector 1000.

Referring to FIGS. 2 and 4-8, the shielding member 400 is provided with a groove 410 and an accommodating hole 420. The groove 410 configured as a bracket shape is located at one end 401 (i.e., an upper end) of the shielding member 400 abutting against the top wall 230 so as to accommodate the second fastener 300. The accommodating hole 420 is communicated to a bottom side 411 of the groove 410 so as to accommodate a portion of the first fastener 100 passing through the second fastener 300. In the illustrated embodiment, two opposite sides of the groove 410 are both open (see FIGS. 2 and 6-8), that is, the bracket-shaped groove 410 is configured to have two openings to expose two opposite sides of the second fastener 300, so that the exposed opposite sides of the second fastener 300 are abutted against the opposite side walls 210, respectively, and the second fastener 300 is completely wrapped by the two side walls 210 and the top wall 230 of the housing 200, and the shielding member 400 together. However, the present disclosure is not limited to this, and the opposite sides of the groove 410 may also be constructed as closed, so that the shielding member 400 may wrap the second fastener 300 along an entire circumference of the second fastener 300. The groove 410 may also be constructed to be any other suitable shape that may completely wrap the second fastener 300 together with the housing 200.

Referring to FIGS. 1-3, each of the two side walls 210 is provided with a connecting hole 213. The shielding member 400 is provided with a protrusion 430 on each of its two opposite sides, which is configured to be inserted into the connection hole 213 when the shielding member 400 is inserted into the housing 200 in an insertion direction D (i.e., a direction from bottom to top in FIG. 2), so that the shielding member 400 may be installed in place and fixed in the housing 200, thereby separating the other end 402 (i.e., the lower end) of the shielding member 400 facing away from the top wall 230 from the connecting area 2100 of the circuit board 2000.

In one embodiment of the present disclosure shown in FIGS. 2 and 6, the shielding member 400 is further provided with an elastic arm 440 on each of its two opposite sides, which extends from a main body of the shielding member 400 towards the other end 402 thereof and may be movable in a direction orthogonal to the insertion direction D. The protrusion 430 is provided on the elastic arm 440. The arrangement of the elastic arm 440 greatly facilitates installing the shielding member 400 in place in the housing 200 and fixing the shielding member 400 in the housing 200. Each of the two openings 412 of the bracket-shaped groove 410 is located on the same side of the shielding member 400 as the corresponding one of the protrusions 430 (see FIGS. 2 and 6-8).

Referring to FIG. 9, the present disclosure also includes a connector assembly 3000. The connector assembly 3000 comprises: a bus 600; a first pair of connectors 700, a second pair of connectors 800 and a third pair of connectors 900 electrically connected to one end of the bus 600; a first pair of mating connectors 700′, a second pair of mating connectors 800′ and a third pair of mating connectors 900′ electrically connected to the other end of the bus 600. According to practical use, the bus 600 is selected from one of a thick copper bar, a thin copper bar, and a cable. A fixing point 610 is provided on a main body of the bus 600 so as to fix the bus 600 to a corresponding position on the circuit board.

For clarity, only parts of the circuit board connected to the three pairs of connectors 700, 800, 900, and the three pairs of mating connectors 700′, 800′, 900′ are shown in FIG. 9. Each of the three pairs of connectors 700, 800, 900, and the three pairs of mating connectors 700′, 800′, 900′ is configured to have a structure identical to that of the aforementioned connector 1000. Each of the connectors is correspondingly installed in a connecting area 2100 on the circuit board 2000, allowing the bus 600 to be connected between the three pairs of connectors 700, 800, 900, and the three pairs of mating connectors 700′, 800′, 900′ in a bridging manner.

The first pair of connectors 700 is configured to transmit a control signal, and the first pair of mating connectors 700′ is configured to receive the control signal. The second pair of connectors 800 is configured to transmit a power signal, and the third pair of connectors 900 is configured to transmit another power signal. The second pair of mating connectors 800′ is configured to receive the power signal, and the third pair of mating connectors 900′ is configured to receive the another power signal.

A detailed description of the embodiments of the present disclosure has been provided in conjunction with the accompanying drawings. It should be noted that the implementation not shown or described in the accompanying drawings or the text of the specification are all forms known to the person skilled in the art that the present disclosure pertains to and have not been explained in detail. In addition, the above definitions of each of the components are not limited to the various specific structures, shapes, or methods mentioned in the embodiments, which may be easily modified or replaced by the person skilled in the art.

It should also be noted that in specific embodiments of the present disclosure, unless otherwise expressly stated, the numerical parameters in this specification and the attached claims are approximate values that may be changed based on the desired characteristics obtained by the content of the present disclosure. Specifically, all numbers used in the specification and claims to represent the dimensions, range conditions, etc. of the composition should be understood as being modified by the term “approximately” in all cases. In general, the meaning of the expression refers to an inclusion of a specific number of ±10% changes in some embodiments, ±5% changes in some embodiments, ±1% changes in some embodiments, and ±0.5% changes in some embodiments.

The person skilled in the art may understand that the features recorded in various embodiments and/or claims of the present disclosure may be combined or incorporated in multiple ways, even if such combinations or incorporations are not explicitly recorded in the present disclosure. Specifically, without departing from the spirit and teachings of the present disclosure, the features recorded in various embodiments and/or claims of the present disclosure may be combined and/or incorporated in multiple ways. All these combinations and/or incorporations fall within the scope of the present disclosure.

The specific embodiments described above provide further detailed explanations of the purpose, technical scheme, and beneficial effects of the present disclosure. It should be understood that the above explanations are only specific embodiments of the present disclosure and are not intended to limit the present disclosure. Any modifications, equivalent replacements, improvements, etc. made within the spirit and principles of the present disclosure should be comprised in the protection scope of the present disclosure.

What is claimed is:

1. A connector comprising:
a first fastener; and
a housing, the first fastener arranged on the housing and adapted to secure a wire between the housing and the first fastener, the housing including:
at least one side wall; and
a finger extending from one end of the at least one side wall, the at least one side wall includes a shoulder adapted to withstand external force applied to crimp the finger into a circuit board, a height from the shoulder to the one end of the at least one side wall is sufficient to prevent deformation of the housing during the crimping of the finger into the circuit board.

2. The connector according to claim 1, wherein the at least one side wall includes two opposing side walls, and the housing further including a top wall connected between the two side walls, the first fastener is provided on the top wall and adapted to extend through the top wall.

3. The connector according to claim 2, further comprising a second fastener arranged below the top wall between the two side walls and engaged with the first fastener so as to secure the wire.

4. The connector according to claim 3, further comprising a shielding member arranged between the two side walls so as to at least partially wrap or completely wrap the second fastener and a portion of the first fastener passing through the top wall together with the housing such that there is no gap between the second fastener and the housing.

5. The connector according to claim 4, wherein the shielding member includes a groove located at a first end of the shielding member abutting against the top wall and accommodating the second fastener.

6. The connector according to claim 5, wherein the shielding member includes an accommodating hole communicated to a bottom side of the groove and accommodating a portion of the first fastener passing through the second fastener.

7. The connector according to claim 6, wherein each of the two side walls includes a connecting hole.

8. The connector according to claim 7, wherein the shielding member includes a protrusion on each of its two opposite sides, each of the protrusions adapted to be inserted into a respective on of the connecting holes when the shielding member is inserted into the housing in an insertion direction.

9. The connector according to claim 8, wherein, when the shielding member is installed in place, a second end of the shielding member facing away from the top wall is separated from the circuit board.

10. The connector according to claim 9, wherein the shielding member further includes an elastic arm on each of the two opposite sides.

11. The connector according to claim 10, wherein each elastic arm extends from a main body of the shielding member towards the second end of the shielding member and is movable in a direction orthogonal to the insertion direction, and the protrusion is provided on the elastic arm.

12. The connector according to claim 11, wherein the groove defines bracket shape.

13. The connector according to claim 12, wherein the bracket shape has two openings, each of which is located on the same side of the shielding member as the protrusion.

14. The connector according to claim 3, wherein the connector further includes a gasket arranged between the first fastener and the housing, the wire adapted to be secured between the housing and the gasket.

15. The connector according to claim 14, wherein:
the first fastener is a bolt;
the second fastener is a nut; and
the gasket is abutted against below a head of the bolt so as to secure the wire between the housing and the gasket.

16. A connector assembly, comprising:
a bus;
at least one pair of connectors electrically connected to one end of the bus; and
at least one pair of mating connectors electrically connected to the other end of the bus, each mating connector comprising:
a first fastener; and
a housing, the first fastener arranged on the housing and adapted to secure a wire between the housing and the first fastener, the housing including:
at least one side wall; and
a finger extending from one end of the at least one side wall, the at least one side wall includes a shoulder adapted to withstand external force applied to crimp the finger into a circuit board, a height from the shoulder to the one end of the at least one side wall is sufficient to prevent deformation of the housing during the crimping of the finger into the circuit board.

17. The connector assembly according to claim 16, wherein the at least one pair of connectors includes a first pair of connectors adapted to transmit a control signal, a second pair of connectors adapted to transmit a power signal, and a third pair of connectors adapted to transmit another power signal.

18. The connector assembly according to claim 17, wherein the at least one pair of mating connectors includes a first pair of mating connectors adapted to receive the control signal, a second pair of mating connectors adapted to receive the power signal, and a third pair of mating connectors adapted to receive the another power signal.

19. The connector assembly according to claim 16, wherein the bus is one of a copper bar or a cable.

20. The connector assembly according to claim 16, wherein:
the at least one side wall includes two opposing side walls, and the housing further including a top wall connected between the two side walls, the first fastener is provided on the top wall and adapted to extend through the top wall; and
each mating connector further includes:
a second fastener arranged below the top wall between the two side walls and engaged with the first fastener so as to secure the wire; and
a shielding member arranged between the two side walls so as to at least partially wrap or completely wrap the second fastener and a portion of the first fastener passing through the top wall together with the housing such that there is no gap between the second fastener and the housing.
